(19) United States
(12) Patent Application Publication
(10) Pub. No.: US 2026/0330334 A1
(43) Pub. Date: Oct. 22, 2026

(54) DECENTRALIZED STORAGE-SLOT RESERVATION IN A HETEROGENEOUS PHYSICAL ARTIFICIAL INTELLIGENCE (AI) SWARM

(71) Applicant: Dorian Cartwright, San Jose, CA (US)

(72) Inventor: Dorian Cartwright, San Jose, CA (US)

(21) Appl. No.: 19/654,785

(22) Filed: Apr. 22, 2026

(51) Int. Cl. G06Q 10/02

(52) U.S. Cl. CPC G06Q 10/02

(57) ABSTRACT

Decentralized storage-slot reservation in a multi-robot system includes transmitting, from a first robot to one or more peer robots, a reservation message identifying a bounded storage region, a geometric footprint of a first carried object within the bounded storage region, and a first occupancy interval. A second reservation message is received from a second robot and identifies a geometric footprint of a second carried object and a second occupancy interval for the bounded storage region. The robots execute, without a central scheduler, a reservation-resolution protocol that determines a conflict based on both temporal overlap and geometric incompatibility of the first and second geometric footprints within the bounded storage region. Responsive to the conflict, a motion plan of at least one robot is modified to perform deferred placement or alternate in-space placement of the corresponding carried object.

### FIELD OF THE INVENTION

The present disclosure relates generally to computers and physical artificial intelligence (AI), and more specifically, to decentralized reservation of bounded storage regions by peer robots based on both geometric footprint compatibility and temporal occupancy overlap, without reliance on centralized infrastructure, including without a central scheduler, central controller, or centralized server.

### BACKGROUND

Multi-robot systems are increasingly used in warehouses, fulfillment centers, manufacturing environments, hospitals, retail backrooms, refrigerated logistics, and other environments in which autonomous robots transport and place objects into bins, shelves, totes, pallet zones, rack cells, floor-marked areas, or other bounded storage regions.

In many conventional deployments, assignment of storage locations and sequencing of robot access are handled by a centralized fleet-management server. The central controller may maintain a global occupancy model, assign storage targets, and instruct robots when to approach, wait, place, or reroute. Although such centralized systems can coordinate multiple robots, they also introduce architectural drawbacks.

For example, as the robot population grows, the computational burden on the central scheduler increases. The central server may become a bottleneck for reservation computation, update dissemination, and conflict resolution. Network latency and stale state propagation may reduce responsiveness, particularly when robots are operating in dense environments with short planning horizons. A failure or disconnection of the central server can further impair operation of the robotic fleet.

Existing decentralized techniques have addressed matters such as robot-to-robot collision avoidance, local path negotiation, and distributed task assignment. However, such techniques do not adequately address coordinated reservation of shared storage space based jointly on spatial compatibility of differently shaped objects and temporal overlap of expected occupancy intervals. In many cases, two robots may be able to avoid collision during transit, yet still contend for the same shelf cavity, tote, bin, or pallet position in a manner that creates a placement conflict.

More particularly, conventional approaches often fail to account for situations in which two objects have different geometric footprints, orientations, clearance requirements, or handling constraints, such that both objects cannot be placed within the same bounded storage region during overlapping time intervals. These conflicts may not be apparent from route planning alone.

There is therefore a need for robust techniques that permit robots to reserve storage regions directly with peer robots, determine conflicts using both temporal and geometric criteria, and modify motion plans in a decentralized manner to support deferred placement, alternate in-space placement, or other conflict-resolution outcomes, without requiring a central scheduling server.

### SUMMARY

The present disclosure addresses the foregoing shortcomings with methods, systems, and computer-readable media for decentralized storage-slot reservation in a multi-robot system.

In one embodiment, a first robot transmits to one or more peer robots a reservation message identifying a bounded storage region, a geometric footprint of a first carried object within the bounded storage region, and a first occupancy interval. The first robot receives from a second robot a second reservation message identifying a geometric footprint of a second carried object and a second occupancy interval for the bounded storage region.

The first robot and the second robot execute, without reliance on centralized infrastructure and without a central scheduler, a reservation-resolution protocol that determines whether a conflict exists based on both temporal overlap and geometric incompatibility of the first and second geometric footprints within the bounded storage region.

Responsive to the conflict, a motion plan of at least one robot is modified to perform deferred placement or alternate in-space placement of the corresponding carried object.

In some embodiments, deferred placement comprises delaying insertion of the carried object into the bounded storage region until expiration of an overlapping portion of the occupancy intervals.

In some embodiments, alternate in-space placement comprises rotating the carried object, translating the carried object to a non-overlapping subregion, changing insertion angle, selecting a different pose, or otherwise altering placement within the same bounded storage region to achieve geometric compatibility.

In some embodiments, the reservation-resolution protocol applies one or more priority rules based on at least one of arrival time, task urgency, object perishability, travel cost, battery state, handling constraints, service level, robot class, negotiated utility, or reservation seniority.

In some embodiments, the protocol is bilateral between two robots. In other embodiments, the protocol extends to three or more robots contending for the same bounded storage region.

In another aspect, the present disclosure provides a multi-robot system including onboard processors, memory, peer-to-peer communication interfaces, and actuators configured to perform decentralized reservation exchanges and conflict-responsive motion-plan modification.

In still further embodiments, the bounded region comprises a shared resource region including a charging bay, charging lane, battery-swap region, tool dock, fixture station, calibration station, scanner booth, pallet wrapper, workcell, handoff area, or other operational region. Reservation conflicts for such regions may trigger deferred use, alternate resource selection, resource-use reordering, or task reassignment rather than object placement changes alone.

### BRIEF DESCRIPTION OF THE DRAWINGS

The present disclosure will be understood more fully from the detailed description given below and from the accompanying drawings of various embodiments of the disclosure.

FIG. 1 is a perspective diagram illustrating an example multi-robot environment including multiple peer robots and one or more shared bounded storage regions, according to an embodiment.

FIG. 2 is a more detailed block diagram of an AI robot of FIG. 1, according to an embodiment.

FIG. 3A is a more detailed block diagram of a shared occupancy data module of FIG. 2, according to an embodiment.

FIG. 3B is a more detailed block diagram of a physical AI platform of FIG. 2, according to an embodiment.

FIG. 4 is an example of a computing environment of system components, according to an embodiment.

FIG. 5 is a flow chart illustrating a method for decentralized reservation of a bounded storage region by peer robots, according to an embodiment.

FIG. 6 is a diagram illustrating a multi-party contention scenario in which three or more robots negotiate feasible ordering and/or placement sets for a common bounded storage region, according to an embodiment.

### DETAILED DESCRIPTION

The present disclosure provides multi-robot methods, systems and computer program products for decentralized coordination techniques for shared physical storage space. Rather than relying on a central scheduler to maintain exclusive control over storage assignments, peer robots exchange reservation data directly and evaluate conflicts locally using onboard processing.

As used herein, a “bounded storage region” refers to any physical region having finite geometric boundaries and capable of receiving one or more placed objects. In some embodiments, the bounded storage region is one example of a broader “bounded operational region,” which refers to any physically constrained region, access region, or resource-associated region for which occupancy, access, use, or traversal may be reserved over time. Non-limiting examples include a shelf cavity, tote, bin, rack cell, pallet position, floor-marked zone, refrigerated compartment, staging area, drawer, cubby, container volume, handoff area, conveyor merge point, temporary transitional space, workcell, charger bay, charging lane, tool dock, fixture station, calibration station, scanner booth, pallet wrapper, service bay, or other defined storage or resource space.

As used herein, a “geometric footprint” refers to a representation of space occupied, expected to be occupied, or required to remain available within a bounded operational region. In some embodiments, the geometric footprint corresponds to a placed object within a bounded storage region. In other embodiments, the geometric footprint corresponds to an activity footprint, access footprint, manipulator envelope, docking envelope, cable-clearance region, connector-approach corridor, tool-swing envelope, human-separation region, or other spatial descriptor associated with use of a shared operational region. The footprint may be two-dimensional, three-dimensional, or pose-dependent. The footprint may include dimensions, polygonal boundaries, volumetric boundaries, orientation envelopes, clearance regions, insertion corridors, gripper release constraints, cable or hose routing constraints, service-access constraints, stacking constraints, or other spatial descriptors.

A conflict is not limited to two robots physically colliding in transit. Instead, the present disclosure focuses on a storage or operational conflict in which overlapping time windows and incompatible spatial requirements indicate that intended placements, uses, accesses, or traversals cannot coexist as planned within the same bounded region.

A conflict may therefore arise in a variety of forms. In one example, two robots intend to place incompatible objects within the same bounded storage region during overlapping time intervals. In another example, two robots intend to use the same charger bay, tool dock, fixture station, or workcell during overlapping intervals such that their corresponding access footprints, docking envelopes, manipulator envelopes, or resource-specific constraints cannot coexist. In still another example, a conflict arises where simultaneous use would violate a policy constraint, a capacity limit, a safety envelope, or a required separation distance associated with the bounded operational region.

### I. Systems for Decentralized Reservation-Resolution

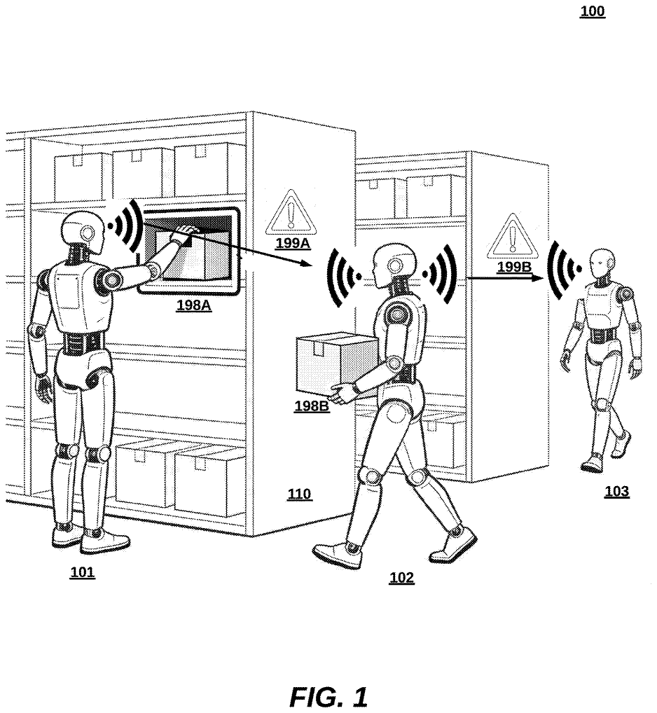

In FIG. 1, a perspective diagram illustrates a system 100 for decentralized storage-slot and bounded-region reservation, according to an embodiment. The system 100 includes a first robot 101, a second robot 102, and a third robot 103. The robots may be autonomous mobile robots, robotic arms on mobile bases, humanoid robots, warehouse transport robots, delivery robots, inventory robots, or other robotic devices capable of carrying and placing objects 198A, 198B on shelving 110 with cubby holes.

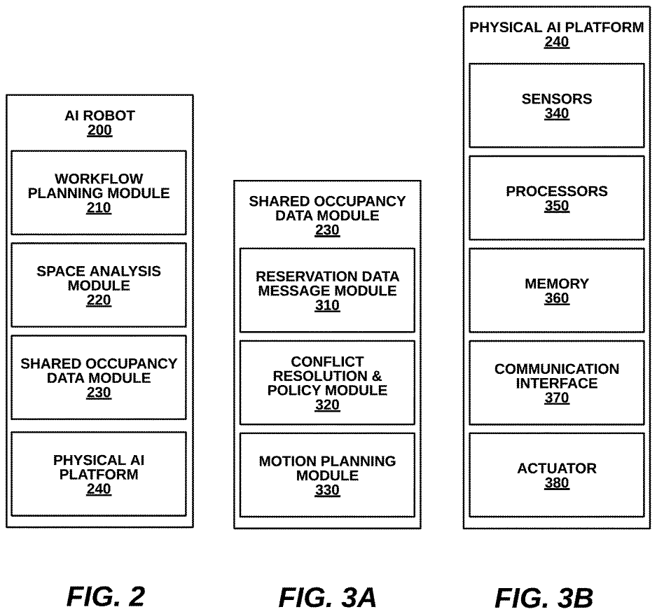

In FIG. 2, a block diagram illustrates internal components of a robot 200 (e.g., robots 101, 102, 103), according to an embodiment. The robot 200 includes a workflow planning module 210 to set overall goals and tasks, a space analysis module 220 to process local reservation data specifically and spatial data in general, a shared occupancy data module 230 to exchange reservation data, and a physical AI platform 240 to interact with the real-world environment.

In FIG. 3A, the shared occupancy data module 230 includes a reservation data message module 310 to exchange or at least receive reservation data, a conflict resolution and policy module 320 to locally process or at least preprocess received data, and a motion planning module 330 to respond to spatial conflicts, according to policy.

In FIG. 3B, the physical AI platform 240 includes sensors 340 for input from a real-world environment, processors 350 to execute general and inferencing tasks, memory 360 to store computer-executable instructions, communications interface 370 to receive and transmit data over a channel, and actuators 380 to manifest actions on the real-world environment.

Many other variations are possible.

Each robot may carry an object toward a target bounded storage region. In one example, the first robot 101 carries a first package 198A toward a shelf 110 cavity while the second robot 102 carries the second package 198B toward the same shelf 110 cavity. In another example, multiple robots contend for a pallet position, tote, or refrigerated slot.

Each robot may include a local world model, a motion planner, a manipulator controller, and a communication module. The robots may communicate over a wireless peer-to-peer network, mesh network, ad hoc network, local wireless LAN, private 5G network, Bluetooth-type network, ultra-wideband system, or any suitable robot-to-robot communication medium.

Although peer-to-peer decentralized reservation is emphasized, aspects of the disclosure may be combined with hybrid architectures including intermittent centralized coordination, infrastructure-assisted communication, or resource-side verification, while reservation-resolution for at least some bounded regions remains locally executable by peer robots without reliance on centralized infrastructure for each reservation decision.

### A. Reservation Messages

Referring to FIG. 2, a reservation message sent or receive by the reservation data message module 310 may include a region identifier that identifies the bounded storage region or other bounded operational region for which placement, access, usage, or traversal is intended.

The reservation message may further include geometric footprint data associated with a carried object, an intended placement pose, a manipulator or vehicle access region, a docking envelope, a charging clearance envelope, a tool-use envelope, or another spatial occupancy descriptor as expected within the bounded operational region. The footprint data may specify width, height, depth, polygonal extent, volume, orientation, allowable orientation range, clearance constraints, insertion constraints, cable-clearance constraints, service-access constraints, stacking limitations, or subregion preferences.

In some embodiments, the reservation message further includes robot identifier data, task metadata, handling constraints, fragility indicators, perishability data, battery state, travel cost, confidence values, estimated arrival time, alternative placement options, alternative resource options, policy attributes, capability constraints, zone classifications, or priority data. In some embodiments, zone classifications include safety-constrained zones, hazardous areas, human-priority areas, limited-capacity workcells, or resource-specific access classes. In some embodiments, policy attributes indicate one or more handling, charging, safety, privacy, environmental, or access-control requirements associated with the bounded operational region.

In embodiments involving a charging bay or other energy replenishment region, the reservation message may further include one or more charging-related constraints, such as a requested charging interval, estimated charging duration, charging mode, charging power class, connector type, bay occupancy requirement, cable or arm clearance, battery-swap compatibility, or maximum permissible simultaneous occupancy around the charging region. The disclosed reservation outcome may be used by peer robots to determine which robot is permitted to approach or wait for the charging region, while separate charger-side logic may independently verify charging entitlement before physical power delivery is enabled.

In embodiments involving a shared tool, fixture, calibration station, scanner booth, pallet wrapper, or other non-charging shared resource, the reservation message may identify a bounded resource region together with a corresponding usage interval and one or more resource-specific constraints. A conflict may therefore be detected not only when physical overlap occurs, but also when a region-specific resource cannot support the requested simultaneous use.

In some embodiments, the footprint data is generated from stored object models. In other embodiments, the footprint data is estimated from sensor inputs such as camera data, lidar data, radar data, depth data, barcode data, RFID data, force data, encoder data, or map data.

In some embodiments, the footprint data is not rigidly defined but rather comprises probabilistic occupancy envelopes or uncertainty bounds to account for sensor degradation. Furthermore, the local generation and parsing of the reservation messages, including complex task metadata, may be executed at the edge using a Small Language Model (SLM) operating directly on the robot's NPU or GPU architecture. To prevent malicious interference, the peer robots may negotiate these reservations using authenticated or encrypted peer-to-peer communications.

### B. Reservation-Resolution Protocol

Referring to FIG. 3, upon receiving a second reservation message, the first robot 101 compares the second reservation against its own pending or active reservation for the same bounded storage region.

In one embodiment, the protocol first determines whether the occupancy intervals overlap in time. If no temporal overlap exists, the reservations may both proceed without further geometric analysis. If temporal overlap exists, the protocol determines whether the two geometric footprints are compatible within the bounded storage region.

Geometric incompatibility may be determined in various ways. In some embodiments, incompatibility is determined when the combined area or volume of the footprints exceeds a spatial limit of the bounded storage region. In some embodiments, incompatibility is determined when the two footprints intersect or cannot be arranged in a non-overlapping manner within the bounded storage region while satisfying one or more orientation, clearance, insertion, stacking, center-of-mass, or handling constraints.

In some embodiments, the protocol evaluates one or more feasible placement poses for one or both objects to determine whether a compatible arrangement exists. If no feasible arrangement exists during the overlapping interval, a conflict is declared. The policy or protocol can apply one or more priority rules. A priority rule may depend on first-in-time reservation status, estimated arrival time, task urgency, downstream dependency, battery state, travel cost, handling risk, object perishability, customer priority, robot class, negotiated utility, policy compatibility, region-access capability, prior reliability of reservation compliance, or combinations thereof. Thus, in some embodiments, the reservation outcome reflects not only geometric and temporal feasibility, but also whether a given robot and task are compatible with the policy constraints or operating class of the bounded operational region.

In some embodiments, both robots independently compute the same outcome from a deterministic protocol. In other embodiments, one robot serves temporarily as a local tie-breaker or proposer while the peer robot confirms the result. The protocol can also extend beyond bilateral negotiation and is applied across three or more robots contending for the same bounded storage region. Reservation messages may be propagated among peers, and each robot may locally compute a feasible ordering, mutual exclusion set, or compatible placement arrangement.

In some embodiments, the disclosed protocol is used for decentralized reservation of a charger bay, charging lane, battery-swap station, or other energy replenishment region. A first robot may reserve temporal access to the charging region based on a charging-related occupancy interval and a corresponding docking or clearance footprint. A second robot may transmit a competing reservation for the same region. Responsive to a conflict, one or both robots may defer approach, select an alternate charging region, or reorder access to the charging region without a central scheduler. In some embodiments, a charger device or station independently enforces power-delivery entitlement after the swarm-side reservation outcome, thereby enabling a layered architecture in which swarm-side arbitration and resource-side enforcement are separated.

In some embodiments, the disclosed protocol is used for decentralized reservation of a shared tool, fixture, or service station. For example, a first robot may reserve a calibration fixture or scanner booth for a first usage interval, while a second robot transmits a second reservation for overlapping use of the same shared region. The reservation-resolution protocol may determine that the corresponding usage intervals and access footprints are incompatible and may therefore modify a motion plan or task sequence such that at least one robot defers use, selects an alternate resource, or performs a different queued task while awaiting access.

### C. Motion-Plan Modification

In one embodiment, the motion planning module 330 defers placement. The robot may delay approach to the storage region, wait in a holding area, perform another task, adjust dwell timing, or reschedule insertion until expiration of an overlapping occupancy interval. In another embodiment, the motion planning module 330 alternates in-space placement. The robot may rotate the carried object, alter insertion angle, select a different pose, translate the object to a non-overlapping subregion within the same bounded storage region, or otherwise modify the intended placement geometry while remaining within the same storage region. In still further embodiments, the motion planning module 330 replans the robot drive base, manipulator, or both. The robot may alter speed, waypoint sequence, manipulator articulation, gripper pose, release position, lift height, or approach corridor. In some embodiments, the motion planning module 330 falls back selection of an alternative bounded storage region or alternative bounded operational region if a feasible in-space arrangement or feasible resource-use arrangement cannot be achieved for the originally targeted region.

### D. Example Operation

In an illustrative scenario, a first robot carries a first package to a shelf cavity and transmits a reservation indicating a first geometric footprint and a first occupancy interval. A second robot carries a second package to the same shelf cavity and transmits a second reservation indicating a second geometric footprint and a second occupancy interval.

The robots determine that the occupancy intervals overlap. The robots then determine that the geometric footprints cannot coexist within the shelf cavity during the overlapping interval while satisfying required orientation and clearance constraints.

Based on the conflict, the robots may apply a priority rule. If the first robot has priority, the second robot may modify its motion plan to defer placement until the first occupancy interval ends. Alternatively, if the second package can be rotated into a different non-overlapping pose within the same shelf cavity, the second robot may perform alternate in-space placement instead of waiting.

### E. Robot Hardware Architecture and Computing Environment

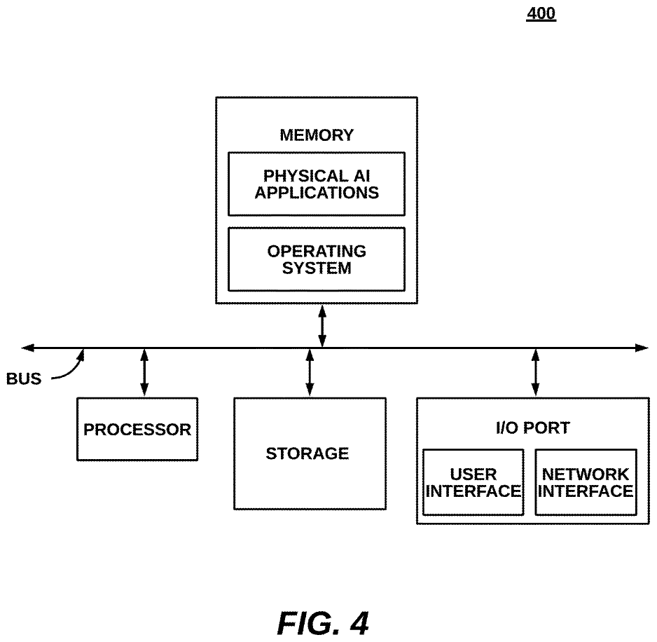

In FIG. 4, a block diagram illustrates a computing environment 400 (e.g., physical AI platform 240) for components of reservation sharing. Each autonomous robot comprises a hardware and software computing environment configured to support physical AI operations, including perception, semantic interpretation, decentralized communication, and motion planning. The computing environment 400 may include one or more processors, such as general-purpose CPUs, graphics processing units (GPUs), neural processing units (NPUs), network processing units, application-specific integrated circuit (ASIC), or other parallel processing architectures, coupled to memory storing executable instructions and data structures, including operating systems and physical AI applications. The system further includes multi-modal sensor interfaces (e.g., vision, depth, lidar, radar, inertial, tactile), communication interfaces supporting peer-to-peer wireless protocols (e.g., Wi-Fi Direct, Bluetooth, ultra-wideband, mesh networking), and actuator control systems for executing physical actions. In some embodiments, the computing environment supports disaggregated AI execution, wherein lightweight on-device models perform real-time inference while selectively interfacing with remote or distributed resources when available. The architecture is configured to operate in offline or intermittently connected environments, enabling decentralized decision-making without reliance on centralized servers, and supports storage and exchange of reservation data structures for use in predictive use of storage and other spatial areas.

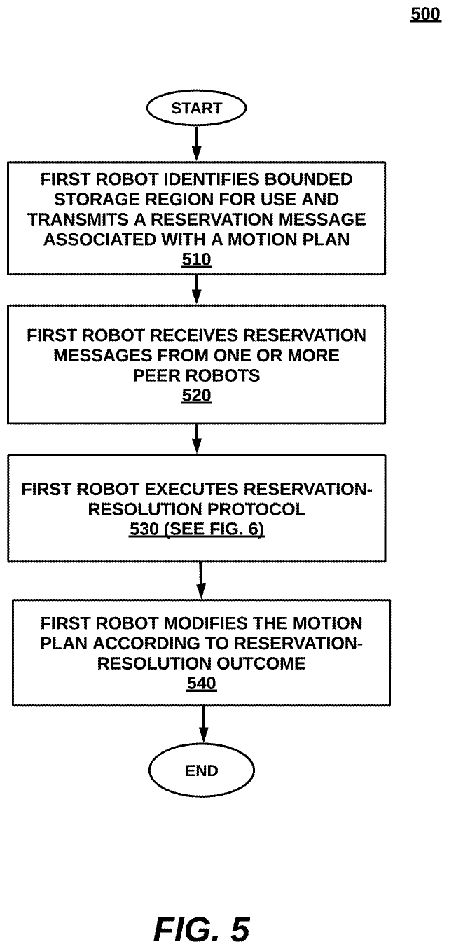

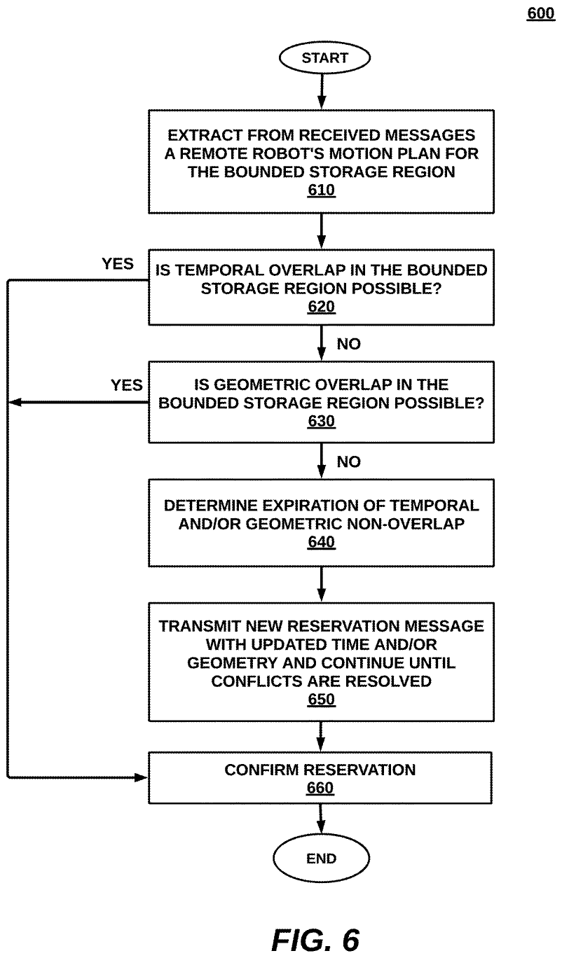

### II. Methods for Decentralized Reservation-Resolution (FIGS. 5-6)

It will be appreciated that the methods described herein are illustrative and not limiting. The steps of the disclosed methods may be performed in any suitable order, and in some embodiments, one or more steps may be omitted, combined, repeated, or performed concurrently. Additional steps may be included without departing from the scope of the present disclosure. Further, individual steps may be implemented using one or more processing components, modules, or distributed systems, and may be carried out in hardware, software, or any combination thereof. Accordingly, the particular sequencing and grouping of steps described herein are provided for clarity of explanation and are not intended to require strict adherence in all embodiments.

### A. Decentralized Reservation of a Bounded Storage Region

In FIG. 5, a flow chart illustrates a method 500 for decentralized reservation of a bounded storage region by peer robots, according to an embodiment.

At step 510, a first robot identifies a bounded storage region for intended placement of a carried object. In some embodiments, the bounded storage region comprises a shelf cavity, tote, bin, rack cell, pallet position, floor-marked zone, refrigerated slot, drawer, cubby, or other finite physical region capable of receiving one or more placed objects. The first robot may further determine a geometric footprint for the carried object within the bounded storage region and may estimate a corresponding occupancy interval during which the carried object is expected to occupy the bounded storage region.

The first robot generates and transmits a reservation message to one or more peer robots. In one embodiment, the reservation message identifies the bounded storage region, the geometric footprint of the carried object, and the occupancy interval. In other embodiments, the reservation message further includes one or more of robot identifier data, estimated arrival time, task metadata, object dimensions, orientation constraints, clearance requirements, handling constraints, fragility indicators, perishability data, battery state, policy attributes, confidence values, uncertainty bounds, or alternative placement options.

At step 520, the first robot receives at least one peer reservation message from a second robot for the same bounded storage region. In some embodiments, the peer reservation message identifies a second geometric footprint and a second occupancy interval corresponding to a second carried object that the second robot intends to place in the same bounded storage region.

At step 530, the first robot and the second robot, without reliance on centralized infrastructure and without a central scheduler, execute a reservation-resolution protocol. In one embodiment, the protocol first determines whether the first occupancy interval and the second occupancy interval overlap in time. Responsive to determining that no temporal overlap exists, both reservations may proceed without further geometric conflict analysis. Responsive to determining that temporal overlap exists, the protocol evaluates whether the first geometric footprint and the second geometric footprint are geometrically compatible within the bounded storage region.

In some embodiments, geometric incompatibility is determined when a combined area or volume of the first geometric footprint and the second geometric footprint exceeds a spatial limit of the bounded storage region. In other embodiments, geometric incompatibility is determined when the first geometric footprint and the second geometric footprint intersect or cannot be arranged in a non-overlapping manner while satisfying one or more orientation, clearance, insertion, stacking, center-of-mass, or handling constraints. In still other embodiments, the protocol evaluates multiple feasible poses or subregion placements for one or both carried objects before determining that a conflict exists.

At step 540, responsive to a determined conflict, the first robot, the second robot, or both modify at least one motion plan according to the reservation-resolution outcome. In one embodiment, the motion-plan modification comprises deferred placement, such that insertion of one carried object into the bounded storage region is delayed until expiration of an overlapping portion of the occupancy intervals. In another embodiment, the motion-plan modification comprises alternate in-space placement, such that one carried object is rotated, translated to a non-overlapping subregion, inserted at a different angle, or otherwise placed in a different pose within the same bounded storage region. In still further embodiments, the motion-plan modification comprises trajectory replanning, holding-pattern execution, alternate task execution, or fallback selection of a different bounded storage region.

In some embodiments, the reservation-resolution protocol applies one or more priority rules in determining which robot defers, modifies placement, or proceeds first. The priority rules may depend on first-in-time reservation status, estimated arrival time, task urgency, downstream dependency, battery state, travel cost, handling risk, customer priority, robot class, negotiated utility, reservation seniority, or combinations thereof.

The method 500 may be repeated continuously as robots move through an environment and update reservations for shared bounded storage regions. In some embodiments, the method is performed entirely through onboard processing and peer-to-peer communication, without routing the reservation determination through a fleet-management server.

### B. Multi-Party Negotiation of Ordering and Placement Sets for a Common Bounded Storage Region

In FIG. 6, a diagram illustrates a method 600 in which three or more robots negotiate feasible ordering and/or placement sets for a common bounded storage region, according to an embodiment.

At step 610, the received messages are parsed to extract a remote robot's motion plan for the bounded storage region, or higher-level intent. The remote motion plan can be compared to the local motion plan to identify conflicts. For example step 620 checks for temporal overlap possibilities and step 630 checks for geometric overlap possibilities.

To resolve the conflict, in one embodiment, expiration of temporal and/or geometric non-overlap are determined, at step 640. To confirm, at step 650, a new reservation message with updated time and/or spatial data is transmitted for confirmation by at least the conflicting peer. New reservation messages may also be received according to updated proposals from peer robots. In one case, a timestamp prioritizes multiple proposals received with different plans.

In another embodiment, to resolve the conflict robots negotiate an ordering and/or placement outcome for the common bounded storage region. In one embodiment, the robots determine an ordered sequence in which a first robot is permitted to place a first object before a second robot and a third robot. In another embodiment, the robots determine that two or more objects may be placed during overlapping intervals if positioned in mutually compatible subregions or poses within the common bounded storage region. In still another embodiment, the robots determine that one or more reservations must be deferred because no compatible simultaneous arrangement exists.

In some embodiments, the negotiation is deterministic such that each robot independently computes the same ordering or compatible placement set from the same propagated reservation data (e.g., via the common reservation protocol). In other embodiments, one robot temporarily serves as a proposer, coordinator, or tie-breaker, and one or more peer robots confirm the proposed outcome. In still other embodiments, the robots apply consensus logic or policy-based arbitration to resolve disagreement.

In one embodiment, each reservation message includes a region identifier, footprint data, and occupancy interval data. In other embodiments, each reservation message further includes priority data, confidence values, policy attributes, handling constraints, or alternative candidate placements. Reservation messages may be propagated directly, rebroadcast to nearby peers, or updated as arrival predictions and placement conditions change. In some embodiments, each robot uses a common reservation protocol.

After reservations are confirmed, at step 660, each robot modifies its motion plan according to the negotiated ordering and/or placement set. A first robot may proceed immediately with placement, a second robot may wait until expiration of an overlapping occupancy interval, and a third robot may modify object orientation or select a non-overlapping subregion within the same bounded storage region. In some embodiments, one or more robots may instead select alternate bounded storage regions, perform intermediate staging, or execute different queued tasks while awaiting access to the common bounded storage region.

The method 600 therefore permits three or more peer robots to negotiate access to a common bounded storage region without a central scheduler. By evaluating both temporal overlap and geometric compatibility across multiple competing reservations, the robots are able to determine feasible ordering and/or placement sets that reduce contention and improve utilization of shared storage space. The same techniques apply to two robots, four robots, or full swarm.

### III. Generalities

The foregoing description of embodiments of the present disclosure has been presented for purposes of illustration and description and is not intended to be exhaustive or to limit the disclosure to the precise forms disclosed. Many modifications, variations, and alternative implementations will be apparent to those of ordinary skill in the art in light of the above teachings. For example, although certain embodiments are described in the context of ground-based delivery robots, the disclosed systems and methods are equally applicable to aerial, submersible, humanoid, or other autonomous systems operating in diverse environments. Similarly, while peer-to-peer decentralized reservation is emphasized, aspects of the disclosure may be combined with hybrid architectures including intermittent centralized coordination or infrastructure-assisted communication.

Therefore, the scope of the invention is defined by the appended claims and their equivalents, rather than by the specific embodiments described herein.

I claim:

1. A method for decentralized storage-slot reservation in a multi-robot system, comprising:
transmitting, from a first robot to one or more peer robots, a reservation message identifying a bounded storage region, a geometric footprint of a first carried object within the bounded storage region, and a first occupancy interval;
receiving, from a second robot that is independent of the first robot, a second reservation message identifying a geometric footprint of a second carried object and a second occupancy interval for the bounded storage region;
executing, among the first robot and the second robot without a central scheduler, a reservation-resolution protocol that determines a conflict based on both temporal overlap and geometric incompatibility of the first and second geometric footprints within the bounded storage region; and
responsive to the conflict, modifying a motion plan of at least one robot to perform either deferred placement or alternate in-space placement of the corresponding carried object.

2. The method of claim 1, wherein the reservation-resolution protocol first determines whether the first occupancy interval and the second occupancy interval overlap in time, and performs geometric incompatibility analysis responsive to determining that the first occupancy interval and the second occupancy interval overlap.

3. The method of claim 1, wherein the geometric incompatibility is determined based on a combined occupied area or volume of the first geometric footprint and the second geometric footprint exceeding a spatial limit of the bounded storage region.

4. The method of claim 1, wherein the geometric incompatibility is determined based on the first geometric footprint and the second geometric footprint being incapable of non-overlapping placement within the bounded storage region while satisfying at least one of an orientation constraint, a clearance constraint, an insertion constraint, or a handling constraint.

5. The method of claim 1, wherein the reservation-resolution protocol applies a priority rule based on at least one of arrival time, task urgency, travel cost, battery state, handling constraints, perishability, service level, or reservation seniority.

6. The method of claim 1, wherein deferred placement comprises delaying insertion of the corresponding carried object into the bounded storage region until expiration of an overlapping portion of the first occupancy interval and the second occupancy interval.

7. The method of claim 1, wherein alternate in-space placement comprises rotating the corresponding carried object or translating the corresponding carried object to a non-overlapping subregion within the bounded storage region.

8. The method of claim 1, wherein modifying the motion plan comprises replanning a trajectory of a drive base, a robotic manipulator, or both.

9. The method of claim 1, wherein the reservation message further includes at least one of a robot identifier, estimated arrival time, object handling metadata, object dimension data, uncertainty data, or alternative placement data.

10. The method of claim 1, wherein the first robot determines the geometric footprint of the first carried object using at least one of camera data, depth data, lidar data, force data, barcode data, RFID data, encoder data, or stored object model data.

11. The method of claim 1, wherein the reservation-resolution protocol is executed using onboard processing by the first robot and the second robot without routing the reservation-resolution protocol through a fleet-management server.

12. The method of claim 1, wherein the reservation-resolution protocol is extended to three or more robots contending for the bounded storage region.

13. The method of claim 12, wherein the three or more robots locally evaluate propagated reservation messages to identify at least one of a feasible ordering, a compatible placement set, or a conflict-free subset of reservations.

14. A multi-robot system, comprising:
a first robot comprising a first processor, first memory, and a first wireless communication interface;
a second robot comprising a second processor, second memory, and a second wireless communication interface;
wherein the first memory and the second memory store instructions that, when executed by the first processor and the second processor, cause the first robot and the second robot to:
exchange reservation messages for a bounded storage region, each reservation message including a geometric footprint of a corresponding carried object and an occupancy interval;
determine, without a central scheduler, a conflict based on temporal overlap and geometric incompatibility of the geometric footprints within the bounded storage region; and
modify a motion plan of at least one of the first robot or the second robot to perform deferred placement or alternate in-space placement of the corresponding carried object.

15. The multi-robot system of claim 14, wherein each reservation message further includes priority data used to resolve the conflict.

16. The multi-robot system of claim 14, wherein at least one of the first robot or the second robot includes a manipulator configured to alter object orientation to perform the alternate in-space placement.

17. The multi-robot system of claim 14, wherein the first robot and the second robot communicate over a peer-to-peer wireless network.

18. The multi-robot system of claim 14, wherein each of the first robot and the second robot includes one or more sensors configured to estimate object dimensions, placement pose, or region occupancy.

19. A non-transitory computer-readable medium storing instructions that, when executed by one or more processors of a robot in a multi-robot system, cause the robot to:
transmit a reservation message identifying a bounded storage region, a geometric footprint of a carried object, and an occupancy interval;
receive from a peer robot a second reservation message for the bounded storage region;
determine, without a central scheduler, whether the reservation message and the second reservation message conflict based on temporal overlap and geometric incompatibility; and
modify a motion plan to perform deferred placement or alternate in-space placement responsive to the conflict.

20. The non-transitory computer-readable medium of claim 19, wherein the instructions further cause the robot to apply a priority rule to select between the deferred placement and the alternate in-space placement.
